(19) United States
(12) Patent Application Publication
(10) Pub. No.: US 2019/0137178 A1
(43) Pub. Date: May 9, 2019

(54) NEGATIVE-PRESSURE CONTINUOUS GRAIN DRYER WITH BUILT-IN HEATING DEVICE

(71) Applicant: THE INSTITUTE OF FOOD SCIENCE AND TECHNOLOGY, JIANGXI ACADEMY OF AGRICULTURAL SCIENCES, NANCHANG (CN)

(72) Inventors: YANBO MA, NANCHANG (CN); JINYING ZHOU, NANCHANG (CN); JIANXIONG FENG, NANCHANG (CN); XUEJING ZHU, NANCHANG (CN); JIALIN HE, NANCHANG (CN); GUIPENG CHEN, NANCHANG (CN); WENHUA XIONG, NANCHANG (CN)

(73) Assignee: THE INSTITUTE OF FOOD SCIENCE AND TECHNOLOGY, JIANGXI ACADEMY OF AGRICULTURAL SCIENCES

(21) Appl. No.: 16/241,607

(22) Filed: Jan. 7, 2019

Related U.S. Application Data
(63) Continuation-in-part of application No. PCT/CN2017/086989, filed on Jun. 2, 2017.

(30) Foreign Application Priority Data
Jul. 5, 2016 (CN) 201610521316.4

(51) Int. Cl. F26B 5/04; F26B 17/16; F26B 3/04; F26B 21/02

(52) U.S. Cl. CPC F26B 5/04; F26B 17/16; F26B 2200/06; F26B 21/024; F26B 3/04

(57) ABSTRACT

The present application discloses a negative-pressure continuous grain dryer with a built-in heating device, wherein the negative-pressure continuous grain dryer comprises a dryer bin, a heating device, and a centrifugal fan. Several levels of the heating devices are disposed from top to bottom in the dryer bin. A grain mixing device is provided below the heating device at each level. Outside the bin, an auxiliary heating device and a natural air inlet are provided in correspondence with the heating device at each level. The auxiliary heating device and the natural air inlet communicate with the grains and the respective heating device in the dryer bin through a perforated baffle plate. The centrifugal fan communicates with each of moisture exhaust vents at each level through an air duct.

### CROSS REFERENCE

The present application is a continuation-in-part application of the PCT application submitted on Jun. 2, 2017 with the application number of PCT/CN2017/086989. The present application claims the priority to Chinese patent application No. 201610521316.4, filed with Chinese Patent Office on Jul. 5, 2016, entitled “Negative-Pressure Continuous Grain Dryer with Built-In Heating Device”, which is incorporated herein by reference in its entirety.

### TECHNICAL FIELD

The present application relates to the technical field of drying equipment and a grain dryer, and in particular to a negative-pressure continuous grain dryer with a built-in heating device and a continuously drying method.

### BACKGROUND

There are mainly three grain drying methods in domestic. The first method is performed by, manual sun-drying. Although the method does not consume energy, the labor cost and the intensity are high and this method is also restricted by sun-drying field and climate conditions; the second method is performed by ventilation and drying using a ground groove. Although the method consumes low energy, the processing capacity is large, and the drying is not uniform as it is limited by moisture of the grain when being put into storage; the third method is performed by drying using a drying machine. Although the method has high drying efficiency and short drying time without limitation of the grain moisture when being put into storage, the energy consumption is relatively high, the quality is reduced due to the fact that the grain is forced maturity because of rapid drying, and it is easy to generate crackle or break. A negative-pressure continuous grain dryer with a built-in heating device is used for drying grains, which does not restricted by sun-drying field, climate conditions and grain moisture when the grains are put into storage, and has the following characteristics: 1. higher yield of a single machine and a lower production cost; 2. continuous feeding and continuous drying of the grains achieved; 3. good quality of dry grains with lower crackle or break; 4. grain “condensation” avoided during drying when drying is conducted under negative-pressure; 5. double-drying achieved; 6. simple-structure and ease of maintenance for the dryer.

### SUMMARY

The present application provides a negative-pressure continuous grain dryer with a built-in heating device, wherein the grain is continuously subjected to “stage” drying so as to enable the grains to achieve “uniform” drying by uniformly distributing a heating device in a bin, according to a drying principle of high-humidity to high-temperature and low-humidity to low-temperature.

The present application is achieved by a negative-pressure continuous grain dryer with a built-in heating device, comprising a dryer bin, a heating device, and a centrifugal fan, wherein a plurality of levels of the heating devices are disposed from top to bottom in the dryer bin, a grain mixing device is provided below the heating device at each level, an auxiliary heating device and a natural air inlet are provided outside the bin and in correspondence with the heating device at each level, the auxiliary heating devices and the natural air inlets are in communication with the grains and the heating devices in the dryer bin through a perforated baffle plate, the centrifugal fan is in communication with each of moisture exhaust vents at each level through an air duct.

The present application has the following technical effects:

1. grains in the bin of the dryer slowly pass through a heating layer and a non-heating layer from top to bottom under the action of the gravity, which naturally forms the process: drying→tempering→drying→tempering . . . drying, and realizes a “separated-process” drying of grains;

2. a “sectional” drying of the grains is realized by setting or adjusting medium temperature of the heating device by virtue of different moisture sections of each layer of grains in dryer bin according to the drying principle of “high-humidity to high-temperature” and “low-humidity to low-temperature”;

3. the heating devices are uniformly distributed in dryer bin, so that the ventilation path is short, the power consumption is low, and the grains are treated by basically uniform heat conduction (radiation and convection) after the grains pass through the heating layer, and there is a small temperature difference between the inner layer and the outer layer in, dryer bin (generally about 3-5°C.), thus achieving a balanced drying for the grains;

4. the non-heated layer in dryer bin is equipped with a grain mixing device to cross-mix the grains at different temperatures, and realize heat conduction and heat radiation between each other to achieve “uniform” drying of the grains;

5. the dryer uses the electromagnetic vibrating feeder to continuously discharge, and controls the moisture content of the grains after drying (a level of moisture should be set according to the drying requirements) by adjusting the discharge amount of the feeder, so as to avoid crackle and break due to several times of lifting and realizing “continuous” drying of the grains;

6. the heat source carrier of the heating device is relatively wide: liquid such as hot water and heat conduction oil, gas such as hot air, heat source bodies such as electric furnace wire, electric heating tube, and a carbon crystal electric heating plate.

Another objective of the present application is to provide a negative-pressure continuous dryer capable of automatically adjusting drying temperature and drying time according to moisture content of grains and a continuously drying method.

The present application provides a negative-pressure continuous dryer which includes:

a bin body, provided with a feed inlet arranged at the top of the bin body and a feed outlet arranged at the bottom;

a plurality of drying layers, distributed in the bin body along motion direction of materials; and

a negative-pressure device, communicated with an air outlet of the bin body to exhaust air from the bin body;

The negative-pressure continuous dryer further includes a control device and a detection device electrically connected with the control device, wherein the detection device includes a moisture detection device, and the moisture detection device is at least arranged at the feed inlet and the feed outlet;

and a feed outlet adjustment device and several heating units arranged in each drying layer, wherein the heating units and the feed outlet adjustment device are all electrically connected with the control device;

the control device controls the operation of the heating units according to the detection results of the moisture detection device at the feed inlet;

and the control device controls the operation of the feed outlet adjustment device according to the results of the moisture detection device at the feed outlet.

The control device controls the operation of the heating unit in the drying layer adjacent to the feed inlet according to the detection results of the moisture detection device at the feed inlet.

The detection device further includes a temperature sensor arranged in each drying layer, the temperature sensor is electrically connected with the control unit, and the control unit controls the operation of the heating unit in the downstream adjacent next level of drying layer according to the detection results of the temperature sensor in the upstream above level of drying layer.

Each drying layer is correspondingly provided with an air inlet and an air outlet, each air outlet is communicated to the negative-pressure device; and the dryer further includes an external heating unit arranged at each air inlet.

A mixing device is further arranged at the upstream and/or downstream of at least one drying layer, and the mixing device is arranged at the inner wall of the bin body.

The air inlet and the air outlet of each drying layer are arranged on the side wall of the bin body, the air inlet and the air outlet are both provided with perforated baffle plates, and a protective cover encircled by multiple perforated baffle plates is arranged outside the external heater.

The negative-pressure device is a centrifugal fan, and the centrifugal fan is connected to each air outlet via an air duct.

The present application provides a continuously drying method which adopts the above negative-pressure continuous dryer to perform the following operational steps:

S1: materials enter the bin body via the feed inlet;

S2: the materials are heated and dried in the bin body;

S3: the dried materials are discharged from the feed outlet;

Step S2 further includes:

S21: the moisture detection device at the feed inlet detects the original moisture content of materials, and feeds back results to the control device; and

S22: the control device controls the operation of the heating unit in the drying layer adjacent to the feed inlet according to the above detection results of the original moisture content.

Step S2 further includes the following steps which are performed simultaneously together with step S21:

S23: the temperature sensor in each drying layer detects the temperature of materials in each drying layer, and feeds back results to the control device; and the control device controls the operation of the heating unit in the downstream adjacent next level of drying layer according to the detection results of the temperature sensor in the upstream above level of drying layer.

After step S3, a step S4 is further included:

S41: the moisture detection device at the feed outlet detects the moisture content m after the materials are processed; and

S42: the control device controls the feed outlet adjustment device to adjust the size of the feed outlet according to the moisture content results after processing.

The control device compares the moisture content results after processing with the preset moisture content threshold;

if the moisture content m after processing is smaller than the set moisture content threshold M_{c}, then the feed outlet adjustment device widens the feed outlet; and

if the moisture content m after processing is greater than the set moisture content threshold M_{c}, then the feed outlet adjustment device narrows the feed outlet,

The technical solutions of the present application have the following advantages:

1. The negative-pressure continuous dryer provided by the present application includes a bin body which includes a feed inlet arranged at the top of the bin body and a feed outlet arranged at the bottom, and a plurality of drying layers distributed in the bin body along motion direction of materials. A negative-pressure device which is connected with the air outlet of the bin body exhausts the air in the bin body, and a negative pressure is formed in the bin body, then external air enters via the air inlet. The dryer is provided with a control device, and the control device is connected with a detection device, a heating unit arranged at each drying layer, and a feed outlet adjustment device at the feed outlet. The detection device includes a moisture detection device and a temperature detection device. The moisture detection device includes a moisture detection device arranged at the feed inlet and a moisture detection device arranged at the feed outlet, which are respectively configured to detect original moisture content of materials and the moisture content after materials are processed. The temperature detection device includes a temperature sensor arranged in each drying layer. The control device controls the operating temperature of the heating unit in the drying layer adjacent to the feed inlet according to the detection results of the moisture detection device at the feed inlet, and simultaneously, the control device controls the operating temperature of the heating unit in the next drying layer according to the temperature results detected by the temperature sensor in each drying layer, thereby realizing functions of heating and drying materials at variable temperatures. The control device controls the feed outlet adjustment device to adjust the size of the feed outlet according to the detection results of the moisture detection device at the feed outlet, so as to further control the discharge speed of the dryer. The negative-pressure continuous dryer utilizes the detection results of the moisture detection device at the feed inlet to set the original drying temperature, then each subsequent drying layer sets the drying temperature of the present layer according to the material temperature of the above layer, until materials reach a set moisture content, therefore, materials can be dried to a set value after being dried once, and do not need to be lifted repeatedly, thereby reducing breakage ratio of materials. Meanwhile, the control device can adjust the drying temperature of the heating device at each drying layer according to detection results. With a variable-temperature hot-air drying technology, corresponding drying temperature can be utilized for materials with different moisture contents, thereby avoiding influencing quality of materials due to excessive heating of materials. While the feed outlet control device adjusts the size of the feed outlet according to the detection results of the moisture detection device at the feed outlet, thereby further realizing control of the discharge speed. The shying time of materials in the bin body can be adjusted automatically, such that the moisture content of the processed materials can further reach a set value.

2. As to the negative-pressure continuous dryer provided by the present application, each drying layer is provided with an air inlet and an air outlet, the negative-pressure device is connected with the air outlet via an air duct, so as to extract air in the bin body and foil a negative pressure in the bin body, therefore, air outside the bin enters the bin via the air inlet to form an air flow Then the air flow is heated by a heating unit to become hot air, and the hot air heats and dries the materials when the hot air passes by the materials. The air inlet and the air outlet arranged at each layer enable each drying layer to perform air flow heating independently, thereby realizing temperature control in different layers and different sections.

3. As to the negative-pressure continuous dryer provided by the present application, the heating units in each drying layer are built-in heaters which are arranged at a certain distance between the air inlet and the air outlet, and hot wind in the bin can be subjected to caloric compensation, thereby preventing non-uniform temperatures of materials which are far away from the air inlet.

4. As to the negative-pressure continuous dryer provided by the present application, the air inlet and the air outlet are both arranged on the side wall of the bin body, and the air inlet and the air outlet are both provided with perforated baffle plates, thereby facilitating entering of air. The air inlet is provided with an external heater, and a protective cover which is encircled by multiple perforated baffle plates is arranged outside the external heater. The air at the air inlet can be heated, such that the materials located between the first built-in heater and the air inlet can also be heated and dried.

5. As to the negative-pressure continuous dryer provided by the present application, a mixing device is further arranged at the upstream and/or downstream of each drying layer, and the mixing device is arranged at the inner wall of the bin body, and is configured to exchange internal and external materials in the drying layer, such that the temperature of materials after heating is subjected to heat exchange, the temperatures at each position tend to be uniform, and further the detection results of the temperature sensor are more accurate.

6. As to the continuously drying method provided by the present application, the moisture detection device at the feed inlet detects the original moisture content of materials, and feeds back results to the control device. The control device controls the operation of the heating unit in the drying layer adjacent to the feed inlet according to the detection results of the original moisture content. The control device controls the operation of the heating unit in the downstream adjacent next level of drying layer according to the detection results of the temperature sensor in the upstream above level of drying layer. Finally, the control device controls the feed outlet adjustment device to adjust the size of the feed outlet according to the moisture content results after processing. The original moisture content is utilized, the stage at which the moisture content of the materials is located is judged, and further the heating temperature of the first drying layer is determined, and then the heating temperature of each layer is adjusted according to the detection results of the above layer, such that the heating temperature of each layer is the most proper heating temperature, and different types of moistures which require different temperatures in the materials can all be removed at the most proper temperature, thereby reducing fissure ratio of materials.

7. As to the continuously drying method provided by the present application, the control device compares the moisture content results after processing with the preset moisture content threshold; if the moisture content m after processing is smaller than the set moisture content threshold M_{c}, the feed outlet adjustment device widens the feed outlet; and if the moisture content m after processing is greater than the set moisture content threshold M_{c}, the feed outlet adjustment device narrows the feed outlet, thereby realizing adjustment of the processing time of materials according to detection results after materials are processed. When the moisture content is higher than the set value, then the heating and drying time is increased, such that materials are sufficiently dried; and when the moisture content is lower than a set value, then the heating and drying time is reduced, thereby avoiding influencing quality due to excessive heating of materials.

### BRIEF DESCRIPTION OF THE DRAWINGS

In order to more clearly describe technical solutions in specific embodiments of the present application or in the prior art, a brief introduction will be given below on the accompanying drawings which need to be used in the description of specific embodiments or the prior art. Apparently, the accompanying drawings described below are merely some embodiments of the present application, for those skilled in the art, other drawings can be obtained based on these drawings without any creative effort.

FIG. 1 is a schematic diagram of a structure of the present application.

FIG. 2 is a structural schematic diagram of a negative-pressure continuous dryer in embodiment 2 of the present application;

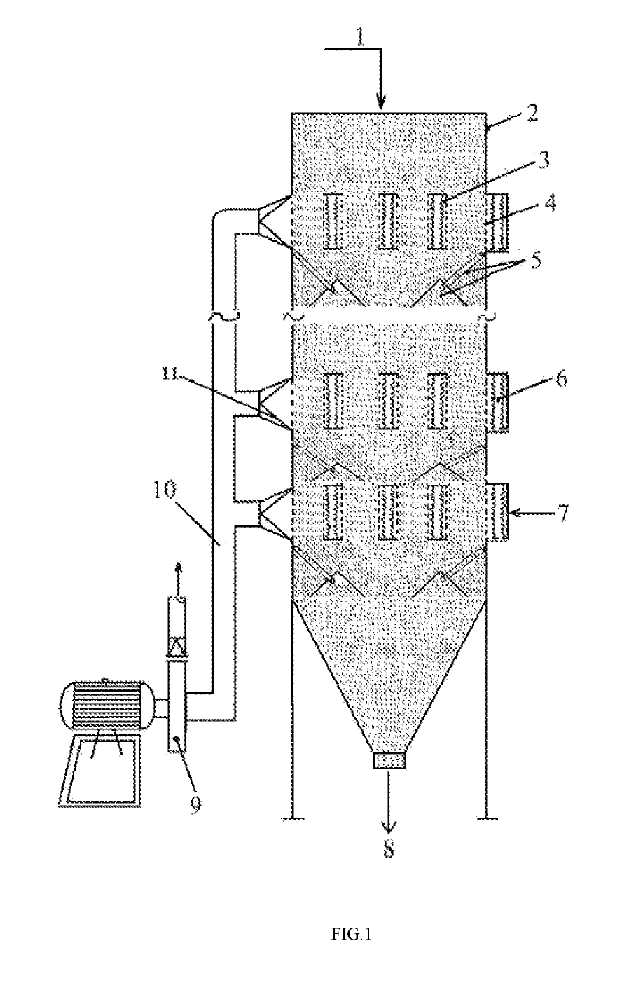

Demonstration for reference numerals in FIG. 1: 1—grain inlet, 2—dryer bin, 3—heating device, 4—perforated baffle plate, 5—grain mixing device, 6—auxiliary heating device, 7—natural air inlet, 8—grain outlet, 9—centrifugal fan, 10—air duct, 11—moisture exhaust vent.

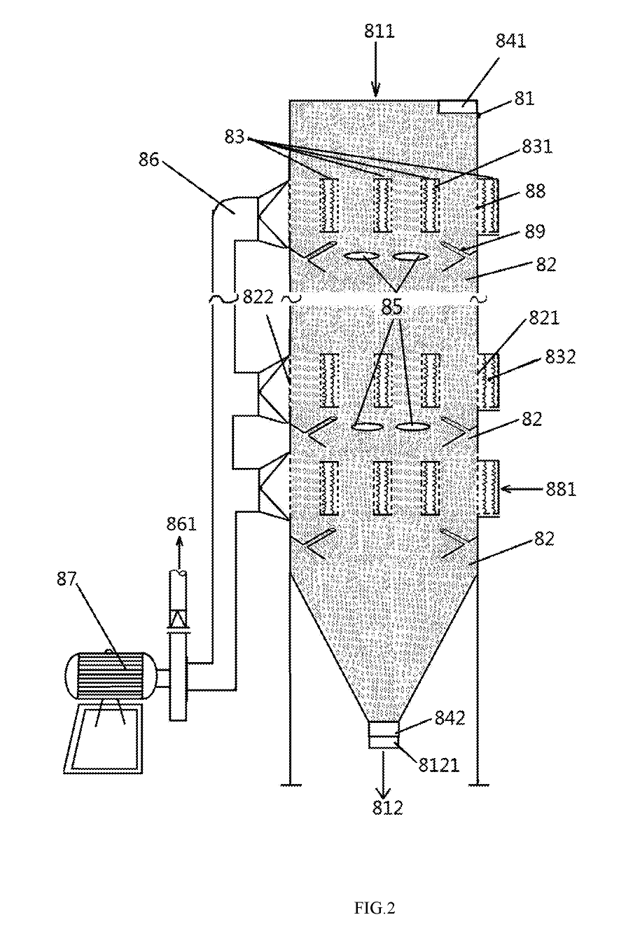

Demonstration for reference numerals in FIG. 2: 81—bin body; 811—feed inlet; 812—feed outlet; 8121—feed outlet adjustment device; 82—drying layer; 821—air inlet; 822—air outlet; 83—heating unit; 831—built-in heater; 832—external heater; 841—first moisture monitor; 842—second moisture monitor; 85—temperature sensor; 86—air duct; 861—moisture exhaust port; 87—centrifugal fan; 88—perforated baffle plate; 881—protective cover; 89—mixing device.

### DETAILED DESCRIPTION

A clear and complete description will be given below on the technical solutions of the present application in combination with the accompanying drawings. Apparently, the described embodiments are merely a part, but not all, of the embodiments of the present application. Based on the embodiments in the present application, all the other embodiments obtained by those skilled in the art without any creative effort shall all fall within the protection scope of the present application.

In the description of the present application, it should be noted that, the directional or positional relationship indicated by such terms as “center” “upper”, “lower”, “left”, “right”, “vertical”, “horizontal”, “inner” and “outer” is the directional or positional relationship shown based on the drawings, which is merely for convenient and simplified description of the present application, rather than indicating or implying that the referred device or element must have the specific direction or must be constructed and operated in the specific direction, therefore, it cannot be understood as a limitation to the present application. In addition, such terms as “first”, “second” and “third” are merely for the purpose of description, rather than being understood as indicating or implying relative importance.

In the description of the present application, it should be noted that, unless otherwise definitely prescribed and defined, the terms “installation”, “connection”, “connected” and the like should be understood in its broad sense. For example, the “connection” may be a fixed connection, may also be a detachable connection or an integrated connection; may be a mechanical connection, may also be an electrical connection; and the “connected” may be directly connected and can also be indirectly connected through an intermediate medium, and can also be the internal communication inside two elements. The specific meaning of the above-mentioned terms in the present application may be understood by those of ordinary skill in the art in light of specific circumstances.

In addition, the technical solutions in different embodiments of the present application described below can be combined with each other as long as the technical solutions do not constitute a conflict.

As shown in FIG. 1, the present application is achieved by a negative-pressure continuous grain dryer with a built-in heating device, comprising a dryer bin 2, a heating device 3, and a centrifugal fan 9, wherein a plurality of levels of the heating devices 3 are disposed from top to bottom in the dryer bin 2, a grain mixing device 5 is provided below the heating device 3 at each level, an auxiliary heating device 6 and a natural air inlet 7 are provided outside the bin 2 and in correspondence with the heating device 3 at each level, the auxiliary heating device 6 and the natural air inlet 7 communicate with the grains and the respective heating device 3 in the dryer bin 2 through a perforated baffle plate 4, the centrifugal fan 9 communicates with each of moisture exhaust vents 11 at each level through an air duct 10, the moist gains enter into the dryer bin 2 through grain inlet 1, undergo “stage” drying, and discharge from a grain outlet 8.

Embodiment: a negative-pressure continuous grain dryer with a built-in five-layer heating device for drying 20 tons of grains (wet basis, similarly hereinafter) each day, is used for drying late long-grain rice in the southern part of the country by adopting a heat source of a coal-fired hot water boiler. The late long-grain rice right after being harvested from the field has a moisture content of 31.5%, while if undergoing a first-time drying, moisture of late long-grain rice after drying is ≤14.5% under the national specified storage standard; if undergoing a second-time drying, the rice is temporarily stored for no longer than 48 hours, and the moisture is should be controlled within 17.5% .

The first time drying is performed by the following steps:

1. Late long-grain rice is cleaned, right after being harvested from the field, by removing impurities such as silt and shriveled rice, and lifted to the dryer bin by a bucket elevator.

2. The moisture section of dried grain is set, wherein, the grains with moisture content from 14.5% to 31.5% is divided into the five sections, i.e., 14.5%-15.5% for partial-high moisture section; 15.5-17.5% for relative-high moisture section; 17.5%-20.5% for high moisture section; 20.5%-24.5% for ultra-high moisture section, 24.5% -31.5% for extra-high moisture section.

3. the temperature of hot water in each layer of heating device in the dryer is set, wherein, the rice is divided into five sections according to the principle of high-humidity for high-temperature and low-humidity for low-temperature, i.e. the temperature of the hot water introduced into each layer of heating device of the dryer is preset and controlled as follows: top layer is at 90° C.; the second layer is at 80° C.; the third layer is at 70° C.; the fourth layer is 60° C.; the bottom layer is at 50° C.

4. a hot water boiler is started, and a hot water pump is started when the temperature of the hot water reaches 90° C., and the hot water is sent to a built-in heating device in the dryer bin including the auxiliary heating device outside the dryer bin,

5. The electromagnetic vibrating feeder is started, and the rice is uniformly discharged from an outlet of the dryer at a flow rate of 14 kg/min, at the moment, the grain does not meet the drying requirement, and the grain is re-lifted to the dryer bin by the bucket elevator. The rice flow is adjusted to ensure that the rice at the top layer of the dryer reaches the outlet or the moisture of the rice reaches 14.5% within 24 hours, and then the rice can be packaged and put into storage.

Finally, the temperature of hot water of each layer of heating devices in the dryer is adjusted according to the moisture requirements of rice after drying, a yield of the dryer can be increased as much as possible (the yield of the dryer is expected to reach 20 tons/24 hours or more) on the premise that the drying quality of the rice is ensured and the moisture of the rice is controlled to be 14.5%.

1. Production cost accounting: coal consumption cost (0.5 ton×600 RMB/ton)=300 RMB; power consumption cost (25 kw×24 hours×0.8 RMB /degree))=480 RMB; labor cost (2 persons×200 RMB/person)=400 RMB.

Total cost=300 RMB+480 RMB+400 RMB=1180 RMB

Production cost=1180 RMB÷20 tons=59 RMB/ton.

The second time drying is performed by the following steps:

1. Late long-grain rice is cleaned right after being harvested from the field, by removing impurities such as silt and shriveled rice, and lifted to the dryer bin by a bucket elevator.

2. the moisture section of dried grain is set, wherein, the grains with moisture content from 17.5% to 31.5% is divided into the five sections, i.e. 17.5%-18.5% for partial-high moisture section; 18.5%-20% for relative-high moisture section; 20-22% for high moisture section; 22%-25% for ultra-high moisture section, 25%-31.5% or extra-high moisture section.

3. the temperature of hot water in each layer of heating device in the dryer is set, wherein, the rice is divided into five sections according to the principle of high-humidity for high-temperature and low-humidity for low-temperature, i.e. the temperature of the hot water introducing into each layer of heating device of the dryer is preset and controlled as follows: top layer is at 90° C.; the second layer is at 85° C.; the third layer is at 80° C.; the fourth layer is at 75° C.; the bottom layer is at 70° C.

4. a hot water boiler is started, and a hot water pump is started when the temperature of the hot water reaches 90° C., and the hot water is sent to a built-in heating device in the dryer bin including the auxiliary heating device outside the dryer bin.

5. The electromagnetic vibrating feeder is started, and the rice is uniformly discharged from an outlet of the dryer at a flow rate of 42 kg/min, at the moment, the grain does not meet the drying requirement, and the grain is re-lifted to the dryer bin by the bucket elevator. The rice flow is adjusted to ensure that the rice at the top layer of the dryer reaches the outlet or the moisture of the rice reaches 17.5% within 24 hours, and then the rice can be packaged and put in storage.

Finally, the temperature of hot water of each layer of heating devices in the dryer is adjusted according to the moisture requirements of rice after drying, a yield of the dryer can be increased as much as possible (the yield of the dryer is expected to reach 60 tons/24 hours or more) on the premise that the drying quality of the rice is ensured and the moisture of the rice is controlled to be 17.5%.

1. Production cost accounting: production scale is calculated by 60 tons/24 h, coal consumption cost (1.2 ton×600 RMB/ton)=720 RMB; power consumption cost (25 kw×24 hours×0.8 RMB/degree))=480 RMB; labor cost (2 persons×200 RMB/person)=400 RMB.

Total cost=720 RMB+480 RMB+400 RMB=1600 RMB

Production cost=1600 RMB÷60 tons=26.7 RMB/ton.

### Embodiment 2

The structure of a negative-pressure continuous dryer provided by the present embodiment is as shown in FIG. 2. The negative-pressure continuous dryer includes a vertically arranged bin body 81, the top of the bin body 81 is a feed inlet 811, and the bottom of the bin body 81 is a feed outlet 812. Grains are poured into the bin body 81 via the feed inlet 811, heated and dried to remove moisture in the bin body 81, and discharged from the feed outlet 812 to finish the drying processing. In the present embodiment, materials pass through the inside of the bin body 81 from top to bottom under the effect of self weight. Multiple drying layers 82 are distributed along the motion direction of materials, and each drying layer 82 is provided with a heating unit 83 which is used for heating and drying materials. An air outlet 822 is formed on a side wall at one side of the bin body 81, the negative-pressure device which is connected with the air outlet 822 of the bin body 81 exhausts air in the bin body 81, and a negative pressure is formed in the bin body 81, such that external air enters via the air inlet 821, then an air flow is formed in the bin body 81, and after being heated by a heating unit 83, the air flow passes by the materials to heat and dry the materials. The air with moisture is exhausted from the air outlet 822 by a negative-pressure device, thereby avoiding reflux condensation of moisture into the bin body 81 which may influence the drying effect.

Specifically, the materials in the present embodiment are grains, and the dryer processes the grains with a high moisture content to be dry to a state applicable for long-term storage, so as to prevent grains from mould.

The dryer in the present embodiment is provided with a control device. A detection device, a heating unit 83 arranged at each drying layer 82, and a feed outlet adjustment device 8121 at the feed outlet 812 are all electrically connected with the control device. The detection device includes a moisture detection device and a temperature detection device. The moisture detection device is a first moisture monitor 841 and a second moisture monitor 842 which are arranged at the feed inlet 811 and the feed outlet 812, respectively. The first moisture monitor 841 is configured to detect the original moisture content of grains which are not dried, while the second moisture monitor 842 is configured to detect the moisture content of grains which are dried by a dryer, and send the detection results to the control device. The temperature detection device includes a temperature sensor 85 arranged in each drying layer 82, and the temperature sensor 85 is configured to detect the temperature of grains which are heated by a heating unit 83 in each drying layer 82, and send the detection results to the control device.

Specifically, the first moisture monitor 841 and the second moisture monitor 842 in the present embodiment are both infrared moisture monitors, and the first moisture monitor 841 and the second moisture monitor 842 set their respective infrared probe at the feed inlet 811 and the feed outlet 812. An infrared light with a certain wavelength is transmitted to the grains, then infrared light reflected by grains is received, and moisture content of grains is calculated according to decrement of infrared light, thereby realizing real-time detection of the moisture content, and timely feeding back to the control device.

As an alternative embodiment, the first moisture monitor 841 and the second moisture monitor 842 in the present embodiment are both milling moisture monitors, and the first moisture monitor 841 and the second moisture monitor 842 set their respective sampling device at the feed inlet 811 and the feed outlet 812, then samples can be rapidly milled to analyze the moisture content, and the moisture content can be detected in real time and fed back to the control device in time.

The control device in the present embodiment sets the operating temperature of the heating unit 83 in the first drying layer 82 adjacent to the feed inlet 811 according to the detection results of the first moisture monitor 841 of the feed inlet 811. The control device sets the operating temperature of the heating unit 83 in the adjacent next level of drying layer 82 according to the temperature results detected by a temperature sensor 85 in each above level of drying layer 82, thereby realizing the functions of heating and drying grains at variable temperatures. For example, the heating temperature of the second level of drying layer is controlled according to the detection temperature of the first level of drying layer, the heating temperature of the third level of drying layer is controlled according to the detection temperature of the second level of drying layer, and so on, wherein the drying layers from the first level to the Nth level are set along the motion direction of materials (namely, set in a sequence from high to low).

The control device in the present embodiment controls the feed outlet adjustment device 8121 to adjust the size of the feed outlet 812 according to the detection results of the second moisture monitor 842 at the feed outlet 812, so as to adjust the discharge speed of the dryer, and further realize the adjustment of drying time of grains. For example, after the moisture content of grains at the outlet is higher than a set value, then the size of the outlet is reduced, and grains stay in the bin body 81 for a longer time to be heated and dried more sufficiently.

A dryer utilizes the detection results of a moisture detection device of the feed inlet 811 to set the original drying temperature, then each of the subsequent drying layer 82 sets the drying temperature of the respective layer according to the temperature of grains of the above layer, until grains reach a set moisture content, therefore, grains can be dried to a preset moisture content threshold after being dried once, and do not need to be lifted to the feed inlet for drying again repeatedly, thereby reducing breakage ratio of grains.

With rice serving as processing objects as an example, when the first moisture monitor 841 detects that the original moisture content of rice is 30%, then the detection results are sent to a control device. The control device compares and judges the detection results to select an extra-high moisture section to be a drying stage required by rice, and further to set the operating temperature of the heating unit 83 in the first drying layer 82 to be between 70° C. and 80° C.. Then the temperature sensor of the first drying layer 82 detects the temperature of rice which is heated by the heating unit 83, for example, the temperature is between 70° C. and 80° C., and then sends the detection results to a control unit. After judgment, the control unit sets the operating temperature of the heating unit 83 of the second drying layer 82 to be between 60° C. and 70° C. The setting of the heating units 83 and the temperature sensors 85 in the third to Nth drying layers 82 can be deduced by analogy

Meanwhile, the control device can adjust the drying temperature of the heating device of each drying layer 82 according to detection results, and adopt different drying temperatures for materials with different moisture contents by utilizing a process of drying in different sections and different layers, for example, the moisture at the surface of wet rice is dried at a high temperature, physical chemical components of rice are dried at a relatively high temperature, and chemical bonding components of rice are dried at a low temperature, thereby not only improving heat efficiency, but also reducing fissure ratio of rice and ensuring drying quality of rice.

The control device at the feed outlet 812 adjusts the size of the feed outlet 812 according to the detection results of the second moisture monitor 842 at the feed outlet 812, thereby realizing control of the discharge speed. The drying time of grains in the bin body 81 can be adjusted automatically, such that the moisture content of processed grains can further reach a set value.

Due to real-time detection of the moisture detection device and the temperature sensor 85 of each drying layer 82, the control device adjusts the operating state of the heating unit 83 in real time, thereby realizing the function of continuously heating and drying. Grains with different moisture contents can be dried continuously, and the dryer does not need to be stopped to adjust the operating temperature, therefore, the working efficiency is improved.

As shown in FIG. 2, the heating units 83 in each level of drying layer 82 in the present embodiment are built-in heaters 831 which are arranged at a certain distance between the air inlet 821 and the air outlet 822, then hot wind in the bin can be subjected to caloric compensation, thereby preventing non-uniform temperatures of grains which are far away from the air inlet 821. Specifically, a protective cover 881 which is encircled by multiple perforated baffle plates 88 is arranged outside each built-in heater 831, such that grains are prevented from being in direct contact with the built-in heater 831, and hot air heated by the built-in heater 831 can be in direct contact with grains, then the heating and drying effect is favorable.

As shown in FIG. 2, each drying layer 82 in the present embodiment is provided with an air inlet 821 and an air outlet 822, the negative-pressure device is connected with an air outlet 822 via an air duct 86 to extract air in the bin body 81, and a negative pressure is formed in the bin body 81, then air outside the bin enters the bin via the air inlet 821 to form an air flow. Specifically, the negative-pressure device in the present embodiment is a centrifugal fan 87. The air flow is heated by a heating unit 83 to become hot air, and when hot air passes by grains, grains are heated and dried. Since each drying layer 82 is provided with an air inlet 821 and an air outlet 822 corresponding thereto, each drying layer 82 can perform air flow heating independently, thereby realizing temperature control in different layers and different sections.

The air duct 86 in the present embodiment is provided with a moisture exhaust port 861 which is used for exhausting air containing moisture, thereby avoiding reflux condensation of moisture into the bin body 81 which may influence the drying effect.

Specifically, as shown in FIG. 2, the air inlet 821 and the air outlet 822 of each layer are arranged on a side wall of the bin body 81 in which the layer is located, the air inlet 821 and the air outlet 822 are both provided with perforated baffle plates 88, thereby facilitating entering of air, and preventing grains from scattering outside the bin body 81. The air inlet 821 is provided with an external heater 832, and a protective cover 881 which is encircled by multiple perforated baffle plates 88 is arranged outside the external heater 832. The air at the air inlet 821 can be heated, such that grains between the first built-in heater 831 and the air inlet 821 can be heated and dried.

As shown in FIG. 2, a mixing device 89 is further arranged at the downstream of each drying layer 82, and the mixing device 89 is arranged on the inner wall of the bin body 81, and is configured to exchange internal and external grains in the drying layer 82, such that grains of each layer can be distributed as uniformly as possible, grains can be ensured to be heated evenly, then temperatures at each position tend to be uniform, and further detection results of the temperature sensor 85 are more accurate.

As an alternative embodiment, the dryer in the present embodiment can also dry seeds, as long as the moisture value sections and Corresponding operating temperature parameters in the control device are modified.

### Embodiment 3

The present embodiment provides a negative-pressure continuous dryer. The structure of the negative-pressure continuous dryer in the present embodiment differs from the structure of the negative-pressure continuous dryer in embodiment 2 in that each drying layer is not internally provided with a temperature sensor, instead, each drying layer is internally provided with a moisture detection device which is configured to detect moisture content of materials in the drying layer. The control device controls the operating temperature of the heating unit in the adjacent next level of drying layer according to the detection results of materials in the above level of drying layer.

### Embodiment 4

The present embodiment provides a continuously drying method. A negative-pressure continuous dryer provided in embodiment 2 is utilized to perform the following operational steps on grains:

S1: grains are sent to the bin body via a feed inlet;

S2: grains are heated and dried in the bin body, including the following steps:

S21: a first moisture monitor at the feed inlet is adopted to detect grains, to obtain original moisture content M₀, and to feed back results to the control device; and

S22: the control device controls the heating temperature of the heating unit in the first drying layer according to detection results of the above original moisture content M₀;

specifically, the control device is input in advance with different drying stages which are in one-to-one correspondence with moisture content range of grains and temperatures of grains, and grains in different drying stages need to be set with a corresponding heating temperature; the control device determines the drying stage Dᵢ at which grains are located according to original moisture content M₀ detected at the feed inlet, and further determines the operating temperature Tᵢ of the heating unit in the first drying layer adjacent to the feed inlet, and sends a temperature adjustment instruction to the heating unit of the first drying layer.

S23: the temperature sensor in the nth drying layer detects the temperature tₙ of grains of each drying layer, wherein n∈ {1,2, . . . N}, and feeds back results to the control device; the control device determines the drying stage Dᵢ at which grains are located according to detection results of the temperature sensor in the upstream nth level of drying layer, and further determines that the heating temperature of the heating unit in the downstream adjacent (n+1)th level of drying layer is Tᵢ₋₁, and sends a temperature adjustment instruction to the (n+1)th level of drying layer.

S3: dried grains are discharged via a feed outlet.

S41: a second moisture monitor at the feed outlet detects moisture content m of processed grains; and

S42: the control device controls the feed outlet adjustment device to adjust the size of the feed outlet according to the moisture content m of processed grains.

Specifically, in S42, the control device compares the moisture content m of processed grains with a preset moisture content threshold M_{c}; if the moisture content in after processing is smaller than the set moisture content threshold M_{c}, then the feed outlet adjustment device widens the feed outlet; and if the moisture content in after processing is greater than the set moisture content threshold M_{c}, the feed outlet adjustment device narrows the feed outlet.

In the continuously drying method in the present embodiment, the first moisture monitor at the feed inlet detects original moisture content of grains, and feeds back results to the control device. The control device controls the operation of the heating unit in the drying layer adjacent to the feed inlet according to the detection results of the original moisture content; and the control device controls the operation of the heating unit in the downstream adjacent next level of drying layer according to the detection results of the temperature sensor in the upstream above level of drying layer. Finally, the control device controls the feed outlet adjustment device to adjust the size of the feed outlet according to the moisture content results after processing at feed outlet of materials.

The original moisture content is utilized, the stage at which the moisture content of grains is located is judged, and further the heating temperature of the first drying layer is determined, and then the heating temperature of each layer is adjusted according to the detection results of the above layer, such that the heating temperature of each layer is the most proper heating temperature, and different types of moistures which require different temperatures in the grains can all be removed at the most proper temperature, thereby reducing fissure ratio of materials.

The control device compares the moisture content results after processing with the preset moisture content threshold M_{c}; if the moisture content m after processing is smaller than the set moisture content threshold M_{c}, then the feed outlet adjustment device widens the feed outlet; and if the moisture content m after processing is greater than the set moisture content threshold M_{c}, the feed outlet adjustment device narrows the feed outlet, thereby realizing adjustment of the processing time of grains according to detection results after grains are processed. When the moisture content is higher than the set value, then the heating and drying time is increased, such that grains are sufficiently dried; and when the moisture content is lower than a set value, then the heating and drying time is reduced, thereby avoiding influencing quality due to excessive beating of grains.

For example, with rice as a serving object as an example, the set moisture content threshold M_{c} is equal to 14.5%.

S1: a lifter is utilized to pour rice into the bin body via the feed inlet;

S21: the first moisture monitor at the feed inlet detects original moisture content M₀ of materials to obtain the result that M₀=30%, and feeds back results to the control device;

S22: the control device compares the original moisture content M₀ with the moisture content range in the following table to obtain that the moisture content of rice is between 24.5% and 31.5%, then the first drying layer should adopt a drying temperature T₅, which is between 70° C. and 80° C., required by an extra-high moisture section D₅;

S23: simultaneously, the temperature sensor in the first drying layer detects that the temperature t₁ of rice of the drying layer is equal to 75° C., and feeds back results to the control device; the control device compares the detection results of the temperature sensor in the upstream first drying layer with the drying temperature in the table, to determine the drying stage D₅ at which grains are located, and further to set the operating temperature T₄of the heating unit in the downstream adjacent second drying layer to be between 60° C. and 70° C. Similarly, the operating temperature T₃ of the heating unit in the third drying layer is set to be between 50° C. and 60° C. according to the temperature t₂ of rice which is 67° C. detected in the second drying layer. The adjustment of operating temperature of the heating unit in each following layer can be deduced in analogy.

TABLE
Moisture Content Sections of Rice

| | | | Drying |
|---|---|---|---|
| | | | temperature |
| i | Drying stage Dᵢ | Moisture content/% | Tᵢ/° C. |
| 1 | partial-high moisture section D₁ | 14.5~15.5 | 40~45 |
| 2 | relative-high moisture section D₂ | 15.5~17.5 | 45~50 |
| 3 | high moisture section D₃ | 17.5~20.5 | 50~60 |
| 4 | ultra-high moisture section D₄ | 20.5~24.5 | 60~70 |
| 5 | extra-high moisture section D₅ | 24.5~31.5 | 70~80 |

S3: dried rice is discharged from the feed outlet;

S41: for example, if the second moisture monitor at the feed outlet detects that the moisture content m after rice is processed is 13.5%;

In S42, the control device compares the moisture content after rice is processed with a preset moisture content threshold M_{c} which is 14.5%, if m is found to be smaller than M_{c}, then the control device controls the feed outlet adjustment device to widen the feed outlet;

Or,

S41: the second moisture monitor at the feed outlet detects that the moisture content m after rice is processed is equal to 15.5%; and

S42: the control device compares the moisture content after rice is processed with a preset moisture content threshold M_{c} which is 14.5%, if m is found to be greater than M_{c}, then the control device controls the feed outlet adjustment device to narrow the feed outlet.

### Embodiment 5

The continuously drying method provided by the present embodiment should be performed by utilizing the negative-pressure continuous dryer provided in embodiment 3, and the continuously drying method in the present embodiment differs from the method in embodiment 4 in that:

S23: the moisture monitor in the nth level of drying layer detects the temperature tₙ of grains of each drying layer, wherein n∈ {1,2, . . . N}, and feeds back results to the control device; the control device determines the drying stage Dᵢ at which grains are located according to detection results of the moisture monitor in the upstream nth level of drying layer, and further determines that the grains in the downstream adjacent (n+1)th level of drying layer uses the drying temperature Tᵢ₋₁ required by the drying stage Dᵢ₋₁, and further sets the operating temperature of the heating unit in the (n+1)th level of drying layer to be Tᵢ₋₁, and sends a temperature adjustment instruction to the (n+1)th level of drying layer.

Apparently, the above embodiments are merely examples given for the purpose of clear description, rather than for limiting the embodiments. For those skilled in the art, other various variations or modifications can be made on the basis of the above description. There's no need and also no possibility to enumerate all the embodiments herein, while the apparent variations or modifications derived herein shall still fall within the protection scope of the present invention.

We claim:

1. A negative-pressure continuous grain dryer with a built-in heating device, comprising
a dryer bin,
a heating device, and
a centrifugal fan,
wherein a plurality of levels of the heating devices are disposed from top to bottom in the dryer bin, a grain mixing device is provided below the heating device at each level,
an auxiliary heating device and a natural air inlet are provided outside the bin and in correspondence with the heating device at each level,
the auxiliary heating devices and the natural air inlets are in communication with the grains and the heating devices in the dryer bin through a perforated baffle plate, the centrifugal fan is in communication with each of moisture exhaust vents at each level through an air duct.

2. A negative-pressure continuous dryer, comprising:
a bin body (81), provided with a feed inlet (811) arranged at the top of the bin body (81) and a feed outlet (812) arranged at the bottom;
a plurality of drying layers (82), distributed in the bin body (81) along motion direction of materials; and
a negative-pressure device, communicated with an air outlet (822) of the bin body (81) to exhaust air from the bin body (81);
further comprising:
a control device and a detection device electrically connected with the control device, wherein the detection device comprises a moisture detection device, and the moisture detection device is at least arranged at the feed inlet (811) and the feed outlet (812);
and a feed outlet adjustment device (8121) and several heating units (83) arranged in each drying layer (82), wherein the heating units (83) and the feed outlet adjustment device (8121) are all electrically connected with the control device; the control device controls the operation of the heating units (83) according to detection results of the moisture detection device at the feed inlet (811); and the control device controls the operation of the feed outlet adjustment device (8121) according to the results of the moisture detection device at the feed outlet (812).

3. The negative-pressure continuous dryer of claim 2, wherein the control device controls the operation of the heating unit (83) in the drying layer (82) adjacent to the feed inlet (811) according to the detection results of the moisture detection device at the feed inlet (811).

4. The negative-pressure continuous dryer of claim 3, wherein the detection device further comprises a temperature sensor (85) arranged in each drying layer (82), the temperature sensor (85) is electrically connected with the control unit, and the control unit controls the operation of the heating unit (83) in the downstream adjacent next level of drying layer (82) according to the detection results of the temperature sensor (85) in the upstream above level of drying layer (82).

5. The negative-pressure continuous dryer of claim 3, wherein each drying layer (82) is correspondingly provided with an air inlet (821) and an air outlet (822), each air outlet (822) is communicated to the negative-pressure device; and the dryer further comprises an external heater (32) arranged at each air inlet (821).

6. The negative-pressure continuous dryer of claim 2, wherein a mixing device (9) is further arranged at the upstream and/or downstream of at least one drying layer (82), and the mixing device (9) is arranged at the inner wall of the bin body (81).

7. The negative-pressure continuous dryer of claim 2, wherein the air inlet (821) and the air outlet (822) of each drying layer (82) are arranged on the side wall of the bin body (81), the air inlet (821) and the air outlet (822) are both provided with perforated baffle plates (8), and a protective cover (881) encircled by multiple perforated baffle plates (8) is arranged outside the external heater.

8. The negative-pressure continuous dryer of claim 2, wherein the negative-pressure device is a centrifugal fan (7), and the centrifugal fan (7) is connected to each air outlet (822) via an air duct (6).

9. A continuously drying method, adopting the negative-pressure continuous dryer of claim 2 to dry materials and comprising the following steps:
S1: materials enter the bin body (81) via the feed inlet (811);
S2: the materials are heated and dried in the bin body (81); and
S3: the dried materials are discharged from the feed outlet (812); wherein
Step S2 further comprises:
S21: the moisture detection device at the feed inlet (811) detects original moisture content of materials, and feeds back results to the control device; and
S22: the control device controls the operation of the heating unit (83) in the drying layer (82) adjacent to the feed inlet (811) according to the above detection results of the original moisture content.

10. The continuously drying method of claim 9, wherein step S2 further comprises the following steps which are performed simultaneously together with step S21:
S23: the temperature sensor (85) in each drying layer (82) detects the temperature of materials in each drying layer (82), and feeds back results to the control device; and the control device controls the operation of the heating unit (83) in the downstream adjacent next level of drying layer (82) according to the detection results of the temperature sensor (85) in the upstream above level of drying layer (82).

11. The continuously drying method of claim 9 wherein after step S3, a step S4 is further included:
S41: the moisture detection device at the feed outlet (812) detects the moisture content m after the materials are processed; and
S42: the control device controls the feed outlet adjustment device (8121) to adjust the size of the feed outlet (812) according to the moisture content results after processing.

12. The continuously drying method of claim 11, wherein step S42 is as follows:
the control device compares the moisture content results after processing with the preset moisture content threshold;
if the moisture content m after processing is smaller than the set moisture content threshold M_{c}, then the feed outlet adjustment device (8121) widens the feed outlet (812); and
if the moisture content m after processing is greater than the set moisture content threshold M_{c}, then the feed outlet adjustment device (8121) narrows the feed outlet (812).

13. The negative-pressure continuous dryer of claim 4, wherein each drying layer (82) is correspondingly provided with an air inlet (821) and an air outlet (822), each air outlet (822) is communicated to the negative-pressure device; and the dryer further comprises an external heater (32) arranged at each air inlet (821).

14. The negative-pressure continuous dryer of claim 3, wherein a mixing device (9) is further arranged at the upstream and/or downstream of at least one drying layer (82), and the mixing device (9) is arranged at the inner wall of the bin body (81).

15. The negative-pressure continuous dryer of claim 4, wherein a mixing device (9) is further arranged at the upstream and/or downstream of at least one drying layer (82), and the mixing device (9) is arranged at the inner wall of the bin body (81).

16. The negative-pressure continuous dryer of claim 5, wherein a mixing device (9) is further arranged at the upstream and/or downstream of at least one drying layer (82), and the mixing device (9) is arranged at the inner wall of the bin body (81).

17. The negative-pressure continuous dryer of claim 3, wherein the air inlet (821) and the air outlet (822) of each drying layer (82) are arranged on the side wall of the bin body (81), the air inlet (821) and the air outlet (822) are both provided with perforated baffle plates (8), and a protective cover (881) encircled by multiple perforated baffle plates (8) is arranged outside the external heater.

18. The negative-pressure continuous dryer of claim 4, wherein the air inlet (821) and the air outlet (822) of each drying layer (82) are arranged on the side wall of the bin body (81), the air inlet (821) and the air outlet (822) are both provided with perforated baffle plates (8), and a protective cover (881) encircled by multiple perforated baffle plates (8) is arranged outside the external heater.

19. The negative-pressure continuous dryer of claim 3, wherein the negative-pressure device is a centrifugal fan (7), and the centrifugal fan (7) is connected to each air outlet (822) via an air duct (6).

20. The continuously drying method of claim 10 wherein after step S3, a step S4 is further included:
S41: the moisture detection device at the feed outlet (812) detects the moisture content m after the materials are processed; and
S42: the control device controls the feed outlet adjustment device (8121) to adjust the size of the feed outlet (812) according to the moisture content results after processing.
